(19) United States
(12) Patent Application Publication
(10) Pub. No.: US 2006/0034476 A1
(43) Pub. Date: Feb. 16, 2006

(54) Headset case arrangement for wind control

(75) Inventor: Abraham Glezerman, Tel-Aviv (IL)

Correspondence Address: DARBY & DARBY P.C., P. O. BOX 5257, NEW YORK, NY, 10150-5257, US

(73) Assignee: Cardo Corp., Tel-Aviv (IL)

(21) Appl. No.: 10/917,258

(22) Filed: Aug. 12, 2004

(51) Int. Cl. H04R 25/00

(52) U.S. Cl. 381/375; 381/370; 381/384

(57) ABSTRACT

A wireless communication headset for reducing wind-induced noise and providing improved microphone performance under a variety of different ambient noise conditions includes a housing defining a cavity and first and second apertures in communication with the cavity. A microphone disposed within the cavity has a transducer oriented along an axis, whereby the first and second apertures are located on opposite sides of the axis. A baffle surrounds the transducer and is oriented along the axial direction. Optionally, a shroud at a forward end of the baffle defines an air space ahead of the transducer. Further still, a liner such as a foam layer or swatch of fabric is disposed within the cavity, providing a diffuse acoustic path between the first and second apertures and the transducer so as to prevent wind flow from directly impinging upon the microphone.

### FIELD OF THE INVENTION

The present invention relates to arrangements for housing microphones used in communication headsets and, more particularly, to a headset case and microphone arrangement configured for eliminating or reducing wind noise.

### BACKGROUND OF THE INVENTION

Hands-free headsets for use with cellular phones and traditional land-line phones are known. One major problem with traditional communication headsets is ambient noise associated with the environment that can be picked up by the headset's microphone and transmitted along with the user's voice. It has long been desired to provide improved microphone performance in devices such as communication headsets that operate under a variety of different ambient noise conditions. It is well-known that wind flow over a microphone will induce significant amounts of low frequency noise. Wind-induced noise is a particular problem for communication headsets, such as those used in connection with cellular phones, when used, for example, outdoors or near an open window in a vehicle.

Although there are several devices in the prior art that attempt to eliminate or reduce wind-induced noise in microphone arrangements, they generally are not acceptable for applications such as communication headsets. As communication headsets become increasingly compact and the parts contained therein more miniaturized, there is less and less space available to accommodate prior art solutions.

### SUMMARY OF THE INVENTION

The present invention overcomes the disadvantages of the prior art by providing a wireless communication headset which reduces wind-induced noise and provides improved microphone performance under a variety of different ambient noise conditions. The communication headset includes a housing defining a cavity and first and second apertures in communication with the cavity. A microphone disposed within the cavity has a transducer oriented along an axis, whereby the first and second apertures are located on opposite sides of the axis. A baffle surrounds the transducer and is oriented along the axial direction. Further still, a liner disposed within the cavity provides a diffuse acoustic path between the first and second apertures and the transducer so as to prevent wind flow from directly impinging upon the microphone.

In accordance with one aspect of the invention, the housing is free of any aperture which is oriented along the axial direction of the transducer and in communication with the cavity. That is to say, there is no opening in the case which directly faces the transducer of the microphone. Additionally, the apertures have an elongated length which is longer than the elongated baffle.

In accordance with yet another aspect of the invention, the liner can comprise a foam layer that extends substantially between the first and second apertures and provides the diffuse acoustic path for substantially all air paths therebetween. The foam layer has an acoustic resistivity of at least 2 acoustic Ω/cm². Furthermore, air paths between the first and second apertures flow in a direction that is perpendicular to the transducer. Alternatively, the liner can comprise one or more fabric swatches, or layers of swatches that overlie the first and second apertures to diffuse air flowing into the cavity.

A communication headset in accordance with further aspects of the present invention includes the foregoing headset components as well as a communication circuit for processing acoustic signals coupled by the transducer.

These and further aspects, features and advantages of the present invention will become more apparent from the following description when taken in connection with the accompanying drawings which show, for purposes of illustration only, a preferred embodiment of the present invention.

### BRIEF DESCRIPTION OF THE DRAWINGS

FIG. 1 is a perspective view of a communication headset in accordance with a preferred embodiment of the present invention;

FIG. 2 is an exploded view of a communication headset in accordance with the preferred embodiment of the present invention; and

FIG. 3 is an exploded view of a partially assembled communication headset in accordance with the preferred embodiment of the present invention.

### DETAILED DESCRIPTION OF PREFERRED EMBODIMENTS

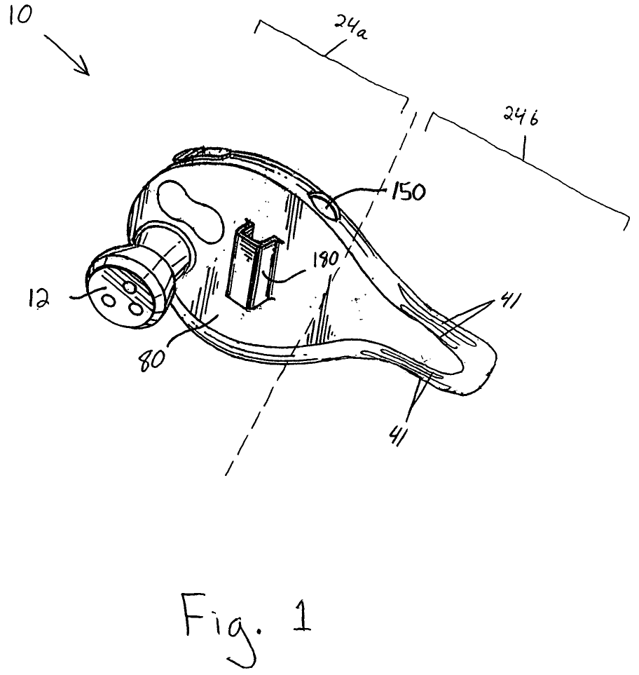

With reference to FIG. 1, a preferred embodiment of the communication headset 10 is illustrated. Communication headset 10 includes a housing 80 having a first portion 24a connected to an earphone 12 for providing audio signals to a user's ear and a second portion 24b connected to a microphone assembly disposed near the user's mouth. Referring to FIGS. 1-3, communication headset 10 includes microphone 16, user operable switches 13, 150, internal communications circuitry 18 and an optional mount 180. Earphone 12 can rest within a user's ear or can be configured to rest proximate to the user's ear by way of an attachment as described in U.S. patent application Ser. No. 10/605,667, filed Oct. 16, 2003, entitled Wireless Communication Headset with Exchangeable Attachments, the entirety of which is hereby incorporated by reference. The power source (not shown) is preferably a rechargeable battery but can also be any of a variety of standard power sources.

Communication headset 10 can be used with any land-line or cellular telephone and with a conventional cellular service provided by a cellular service provider. Headset 10 can also be used with a cellular telephone employing Bluetooth, Wifi, or other wireless technology and, in this case, headset 10 communicates directly with the wireless communication chip in the phone. Bluetooth wireless technology is presently the preferred protocol for wireless communication between the cellular phone and the headset 10. Alternatively, the headset 10 can be used with cellular phones that are not equipped with Bluetooth circuitry by interposing an adapter between the phone and the headset, as described in the aforementioned, co-pending application.

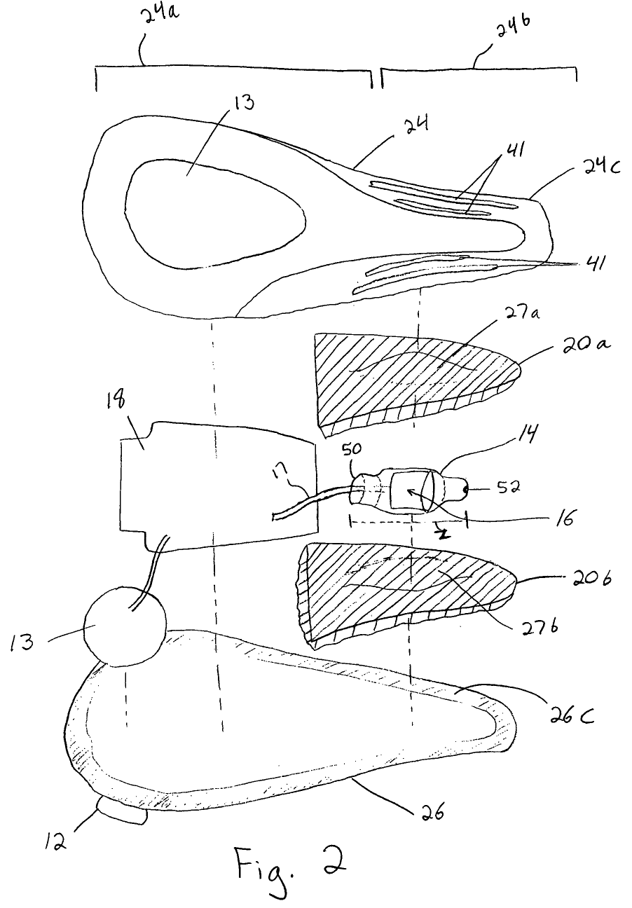

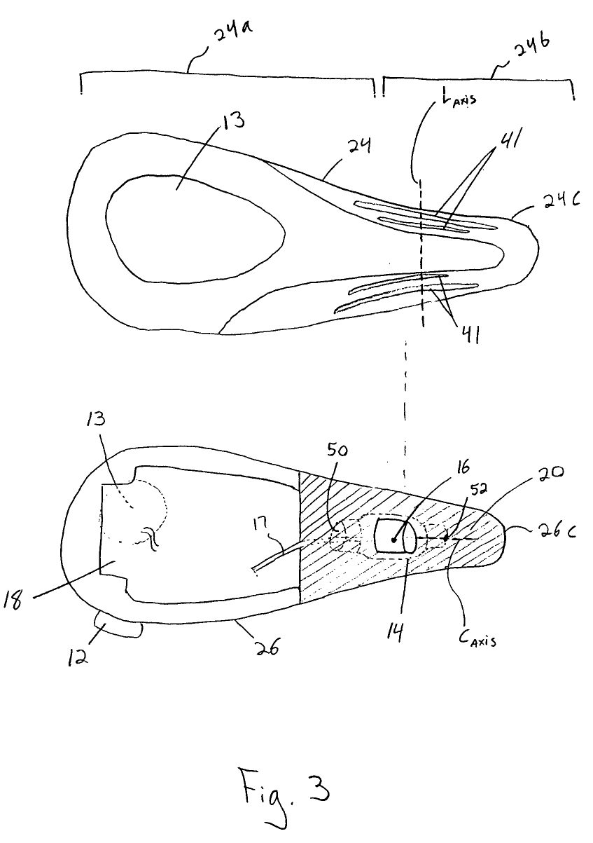

Referring to FIGS. 2 and 3, microphone 16 includes a transducer and has a body disposed in a molded, plastic baffle 14 which is secured within the second portion 24b of the headset 10. Baffle 14 can be arranged to include a shroud that is aligned with an axis of the transducer and leads to a forward port 52. The shroud of baffle 14 provides optimum microphone sensitivity by defining an air space ahead of the microphone 16 transducer and funneling sound waves through port 52 to the microphone 16 while shielding the microphone's transducer from the direct flow of sound waves through the housing. This has the effect of essentially increasing the effective length of the microphone 16 and allowing sound waves to be picked up by the microphone more efficiently. Accordingly, the larger the length Z, the greater the sensitivity of microphone 16. According to a preferred embodiment, length Z is adjusted to achieve optimum microphone sensitivity. Electrical lines 17 are supplied to the microphone by port 50 to transfer power and audio signals to a communication circuit 18. The forward port 52 collects sound waves (i.e., voice signals) from the user to deliver them to microphone 16. A coaxial cable, such as twisted pair or shielded conductors, electrically connects microphone 16 and a speaker 13 of earphone 12 to communication circuitry 18. Communication circuitry 18 provides electronic control functions of communication headset 10 such as processing acoustic signals coupled by the transducer and physically connects and supports the microphone 16 and the speaker 13.

To provide the headset 10 assembly with an improved acoustic response, a liner disposed on an inside surface of the headset housing within a cavity is provided. The liner can comprise an acoustic foam layer 20 that encases the shroud of the baffle, and preferably the entire microphone 16. The liner can alternatively comprise a fabric such as a cloth or an expanded PTFE material (e.g., GOR-TEX brand fabric swatch), and preferably overlies aperture pairs 41 in the housing to thereby diffuse air that flows into the cavity and prevent wind flow from directly impinging upon the microphone, but can be otherwise disposed within the cavity so as to prevent wind flow from directly impinging upon the transducer of the microphone, such as around the transducer and upon the shroud so that a “dead” space of air is available forward of the transducer element. In either arrangement, the impact of wind is buffered more effectively than in conventional case arrangements in which the microphone's transducer is oriented in a direct line of sight with an aperture that couples sound waves from the exterior of the case to an interior region.

Referring to FIG. 2, the headset assembly of FIG. 1 is shown to include an upper and lower housing 24 and 26, respectively, provided from molded plastic. Housings 24 and 26 define a space for housing the components of headset 10, such as, baffle 14, communication circuitry 18, foam layer 20 and speaker 13, and provide second portion 24b with aperture pairs 41 for allowing audible signals to enter headset 10 therethrough. While aperture pairs 41 are shown only appearing on upper housing 24, the apertures can be on either upper or lower housings, or both. According to a salient aspect of the present invention, apertures 41 are located on opposing sides of the microphone's axis (C-axis), e.g., at longitudinal ends of the second portion 24b of headset 10, and can be generally parallel to one another so as to create a substantially parallel airflow through second portion 24b, or can comprise circular openings or non-parallel slots. What is important is that at least one aperture of a pair is displaced on either side of axis C that includes the microphone's transducer.

As illustrated in FIG. 3, the center axis C of microphone 16 is oriented at an angle of about 90° with respect to the axis L in which sound waves are received by the apertures 41.

As illustrated, the liner comprises an acoustic foam layer 20 (20a and 20b), here provided from polyester urethane, a hydrophobic material or any other similar material selected to improve the acoustic properties of the microphone 16 and to match the acoustic properties of baffle 14 to the microphone 16 is disposed in the space created by the housings 24, 26. Referring to FIG. 2, the acoustic foam layer 20 is provided which can seat the baffle 14, e.g., regions 27a, 27b. The foam layer 20 can engage sidewall regions 24c, 26c in housings 24 and 26, respectively, to seal foam layer 20 within headset 10, thereby sealing microphone 16 and baffle 14 in cavity regions 27a and 27b and preventing its movement within. Foam layer 20 provides a diffuse acoustic path between the first and second apertures 41 and the shroud so as to prevent wind flow from directly impinging upon the microphone 16. Preferably, the foam layer 20 provides a diffuse acoustic path for substantially all of the air paths between the aperture pairs 41.

In an alternative arrangement, a diffuse air flow path is achieved by disposing a fabric swatch over the aperture pairs 41. A presently preferred fabric includes an expanded PTFE membrane, such as 100% expanded PTFE, and is available from W. L. Gore & Associates, Inc. in a variety of different forms, but all of their fabrics rated for outerwear are suitable for use as the liner, including their line of WINDSTOPPER(R) fabric. The fabric is selected in thickness and material so as to permit acoustic waves to enter into the housing, yet provide a controlled air-space cavity in front of the microphone's transducer. The fabric liner need not engage or contact the baffle or the shroud, yet will still provide a diffuse acoustic path between the first and second apertures 41 and the shroud so as to prevent wind flow from directly impinging upon the microphone 16. Preferably, the fabric liner, if used, provides a diffuse acoustic path for substantially all of the air paths between the aperture pairs 41.

According to a salient aspect of the present invention housing 80 is free of any aperture which is orientated along the axial direction (C) and in communication with the cavity. Additionally, air paths between the first and second apertures flow in a direction that is perpendicular to the transducer.

Baffle 14, as shown in FIG. 2, has a generally cylindrical shape, but of course could have other cross-sectional geometries, such as rectangular or circular, and the size, shape and location of forward port 52 may be altered so as to adjust the directionality of the microphone. The acoustic resistivity of acoustic foam layer 20, if used as the liner, may be varied to also vary the directionality and polarity of microphone 16. Specifically, the acoustic resistivity of foam layer 20 may be increased to at least about 1 acoustic Ω/cm² and preferably has an acoustic resistivity of at least about 2 acoustic Ω/cm².

Referring to FIG. 3, the liner in the form of the foam layer 20 acts as an acoustic wind diffuser between apertures 41 and the shroud of the baffle 14. Air apertures 41 are similarly disposed on opposing sidewall regions 24c, 26c, such that incoming sound waves in the vicinity of apertures 41 can be directed to microphone 16. The foam layer should preferably be of sufficient porosity or be multiply perforate to allow sound pressure waves to transfer through the particular material, without degrading its frequencies, or bouncing around inside. Foam layer 20 should not decrease the sensitivity of microphone 16 by an appreciable amount and sound essentially passes through the foam layer 20 unobstructed however wind does not. Accordingly, a foam layer possessing at least several of the following qualities is preferred: a smooth, soft and highly contoured surface, a sufficient porosity and depth to slow wind velocity to a crawl (no more than about one or two m.p.h.) so that the microphone is essentially surrounded with nonmoving “dead” air. A “dead” air cavity can be achieved using a fabric liner as previously described, instead of or in addition to the foam layer.

The effect of the liner (e.g., the fabric or acoustic foam layer 20) and the baffle 14 in the communication headset 10 is to alter the polar patterns that can be plotted as compared to plots for a headset assembly without the foam 20 and baffle 14. Specifically, a rear lobe that would be present when the liner and baffle are not provided is effectively eliminated by adding the liner and baffle.

While it has been typical in conventional microphone assemblies to minimize the acoustic resistivity of acoustic foam layers in conventional wind screens by increasing the porosity of the foam layer, the microphone assembly of the present invention advantageously can utilize a foam layer with a higher acoustic resistivity by decreasing the porosity of foam layer and yet obtaining not only better wind-isolation properties, but also improved acoustic characteristics for the microphone assembly. The reduction of the rear lobe of the polar pattern of the microphone assembly is particularly advantageous when communication headset 10 is used outdoors in particular windy environments with substantially no direct air path along the axis of the microphone's transducer.

While the invention has been described with reference to several embodiments thereof, the invention is more broadly defined and limited only by the recitations in the claims appended hereto and their legal equivalents.

I claim:

1. A wireless communication headset comprising:
a housing defining a cavity and first and second apertures in communication with the cavity;
a microphone disposed within the cavity, the microphone having a transducer oriented along an axis, the first and second apertures being on opposite sides of the axis;
a baffle surrounding the transducer and oriented along the axial direction;
a liner disposed within the cavity so as to prevent wind flow from directly impinging upon the transducer of the microphone.

2. The headset of claim 1, wherein the housing is free of any aperture which is oriented along the axial direction and in communication with the cavity.

3. The headset of claim 1, wherein the apertures have an elongated length, and wherein the baffle is axially shorter than the elongated length.

4. The headset of claim 1, wherein the liner overlies the first and second apertures to provide the diffuse acoustic path for substantially all air paths within the cavity.

5. The headset of claim 1, wherein air paths between the first and second apertures flow in a direction that is perpendicular to the transducer.

6. The headset of claim 1, further comprising a communication circuit, the communication circuit being configured to process acoustic signals coupled by the transducer.

7. The headset of claim 1, wherein the liner comprises a swatch of fabric.

8. The headset of claim 7, wherein the swatch of fabric is made of a GORTEX material.

9. A wireless communication headset comprising:
a housing defining a cavity and first and second apertures in communication with the cavity;
a microphone disposed within the cavity, the microphone having a transducer oriented along an axis, the first and second apertures being on opposite sides of the axis;
a baffle having a shroud surrounding the transducer and oriented along the axial direction to define an air space ahead of the transducer;
a foam layer disposed within the cavity and surrounding the shroud, the foam layer providing a diffuse acoustic path between the first and second apertures and the shroud so as to prevent wind flow from directly impinging upon the microphone.

10. The headset of claim 9, wherein the housing is free of any aperture which is oriented along the axial direction and in communication with the cavity.

11. The headset of claim 9, wherein the apertures have an elongated length, and wherein the baffle is axially shorter than the elongated length.

12. The headset of claim 9, wherein the foam layer extends substantially between the first and second apertures to provide the diffuse acoustic path for substantially all air paths therebetween.

13. The headset of claim 9, wherein the foam layer has an acoustic resistivity of at least 1 acoustic Ω/cm².

14. The headset of claim 9, wherein the foam layer has an acoustic resistivity of at least 2 acoustic Ω/cm².

15. The headset of claim 9, wherein air paths between the first and second apertures flow in a direction that is perpendicular to the transducer.

16. The headset of claim 9, further comprising a communication circuit, the communication circuit being configured to process acoustic signals coupled by the transducer.
